(19) United States
(12) Patent Application Publication
(10) Pub. No.: US 2011/0208421 A1
(43) Pub. Date: Aug. 25, 2011

(54) NAVIGATION DEVICE, NAVIGATION METHOD, AND PROGRAM

(75) Inventor: Tatsuya SAKASHITA, Kanagawa (JP)

(73) Assignee: Sony Corporation, Tokyo (JP)

(21) Appl. No.: 13/015,001

(22) Filed: Jan. 27, 2011

(30) Foreign Application Priority Data
Feb. 23, 2010 (JP) 2010-037467

(51) Int. Cl. G01C 21/36

(52) U.S. Cl. 701/201

(57) ABSTRACT

There is provided a navigation device including an acquisition section which acquires position information, a setting section which sets a destination in accordance with operation of a user, a guidance section which shows a route to the destination by using the position information, a switching section which switches a navigation mode to another navigation mode in accordance with operation of a user, and a recording section which records position information of a switching point at which navigation modes are switched by the switching section and the destination in association with each other.

### BACKGROUND OF THE INVENTION

1. Field of the Invention

The present invention relates to a navigation device, a navigation method, and a program.

2. Description of the Related Art

There has been a navigation device, which a moving car is equipped with, that shows a user a current position of the user or a route to a destination. In general, in the navigation device, when the destination is set by operation of the user, an optimal route to the destination is automatically retrieved and the route is displayed on a screen.

However, a point at which the car stopped before arriving at the destination was not set beforehand, and hence, in the case of stopping at the stopping point again, it was necessary that the stopping point be input manually. Therefore, there is disclosed technology for automatically recording a point at which a car previously stopped without the point being manually input by a user, and showing the user the stopping point (for example, JP-A-2006-30051).

### SUMMARY OF THE INVENTION

However, there was an issue in JP-A-2006-30051 that, because the stopping point was registered in accordance with a stoppage time, the stopping point was not registered unless the car stopped for a predetermined time or longer, or even a point on the road which was not the stopping point was registered as the stopping point in the case where the car stopped for a predetermined time or longer at the point.

In light of the foregoing, it is desirable to provide a navigation device, a navigation method, and a program, which are novel and improved, and which are capable of registering an appropriate stopping point regardless of stoppage time.

According to an embodiment of the present invention, there is provided a navigation device which includes an acquisition section which acquires position information, a setting section which sets a destination in accordance with operation of a user, a guidance section which shows a route to the destination by using the position information, a switching section which switches a navigation mode to another navigation mode in accordance with operation of a user, and a recording section which records position information of a switching point at which navigation modes are switched by the switching section and the destination in association with each other.

Further, when the destination is set by the setting section, the guidance section may show a route to the switching point associated with the destination in one navigation mode, and may show a route from the switching point to the destination in another navigation mode.

Further, the navigation device may further include a determination section which determines whether or not there is a road in a vicinity of the switching point. When the determination section determines that there is no road in the vicinity of the switching point, the recording section may record the position information of the switching point and the destination in association with each other.

Further, the determination section may determine that there is a road in the vicinity of the switching point when there is a road network within a predetermined range from the switching point.

Further, the navigation mode may include a car mode, a motorcycle mode, a bicycle mode, and a pedestrian mode.

Further, when the car mode is switched to the pedestrian mode by the switching section, the recording section may record position information of a switching point at which the car mode is switched to the pedestrian mode and the destination in association with each other.

Further, the navigation device may further include a detection section which detects whether or not a main body of the navigation device is mounted on a car. When the detection section detects that the main body of the navigation device is mounted on the car, the switching section may switch the navigation mode to the car mode.

Further, the detection section may detect whether or not the main body of the navigation device is attached to a predetermined base part. When the detection section detects that the main body of the navigation device is attached to the base part, the switching section may switch the navigation mode to the car mode.

Further, when the destination set by the setting section is recorded in the storage medium, the guidance section may cause information which is related to the switching point associated with the destination to be displayed on a display section.

Further, when the destination is set by the setting section, the guidance section may show a route to the switching point associated with the destination in the car mode, and may show a route from the switching point to the destination in the pedestrian mode.

According to another embodiment of the present invention, there is provided a program for causing a computer to function as a navigation device which includes an acquisition section which acquires position information, a setting section which sets a destination in accordance with operation of a user, a guidance section which shows a route to the destination by using the position information, a switching section which switches a navigation mode to another navigation mode in accordance with operation of a user, and a recording section which records position information of a switching point at which navigation modes are switched by the switching section and the destination in association with each other.

In addition, according to another embodiment of the present invention, there is provided a navigation method which includes the steps of acquiring position information, setting a destination in accordance with operation of a user, switching a navigation mode to another navigation mode in accordance with operation of a user, recording position information of a switching point at which the navigation modes are switched and the destination in association with each other, and showing a route to the destination via the switching point by using the position information when the switching point is associated with the destination set in accordance with operation of a user.

According to the embodiments of the present invention described above, an appropriate stopping point can be registered regardless of stoppage time.

### BRIEF DESCRIPTION OF THE DRAWINGS

FIG. 1 is an external view of a PND according to a first embodiment of the present invention;

FIG. 2 is an explanatory diagram illustrating an outline of the embodiment;

FIG. 3 is a block diagram showing a functional configuration of the PND according to the embodiment;

FIG. 4 is an explanatory diagram illustrating selection operation of a navigation mode according to the embodiment;

FIG. 5 is an explanatory diagram illustrating selection operation of the navigation mode according to the embodiment;

FIG. 6 is an explanatory diagram showing a coordinate system around the PND according to the embodiment;

FIG. 7 is a flowchart showing processing of learning a stopping point according to the embodiment;

FIG. 8 is a flowchart showing processing of learning the stopping point according to the embodiment;

FIG. 9 is a flowchart showing processing of learning the stopping point according to the embodiment;

FIG. 10 is a flowchart showing route guidance according to the embodiment;

FIG. 11 is a flowchart showing route guidance according to the embodiment;

FIG. 12 is an external view of a mobile phone according to a second embodiment; and

FIG. 13 is a block diagram showing a functional configuration of the mobile phone according to the embodiment.

### DETAILED DESCRIPTION OF THE EMBODIMENTS

Hereinafter, preferred embodiments of the present invention will be described in detail with reference to the appended drawings. Note that, in this specification and the appended drawings, structural elements that have substantially the same function and structure are denoted with the same reference numerals, and repeated explanation of these structural elements is omitted.

Further, the “detailed description of the embodiments” will be described in the following order.

<1. Object of present embodiments>
<2. First embodiment>
<2-1. Hardware configuration of PND>
<2-2. Functional configuration of PND>
<2-3. Details of operation of PND>
<3. Second embodiment>

### 1. Object of Present Embodiments

First, an object of the present embodiments will be described. There has been a navigation device, which a moving car is equipped with, that shows a user a current position of the user or a route to a destination. In general, in the navigation device, when the destination is set by operation of the user, an optimal route to the destination is automatically retrieved and the route is displayed on a screen.

However, a point at which the car stopped before arriving at the destination was not set beforehand, and hence, in the case of stopping at the stopping point again, it was necessary that the stopping point be input manually. Therefore, there is disclosed technology for automatically recording a point at which a car previously stopped without the point being manually input by a user, and showing the user the stopping point.

However, there was an issue in the technology that, because the stopping point was registered in accordance with a stoppage time, the stopping point was not registered unless the car stopped for a predetermined time or longer, or even a point on the road which was not the stopping point was registered as the stopping point in the case where the car stopped for a predetermined time or longer at the point. Consequently, a navigation device according to the embodiments of the present invention is produced in view of the circumstances described above. According to the navigation device of the present embodiments, it becomes possible to register an appropriate stopping point regardless of stoppage time.

### 2. First Embodiment

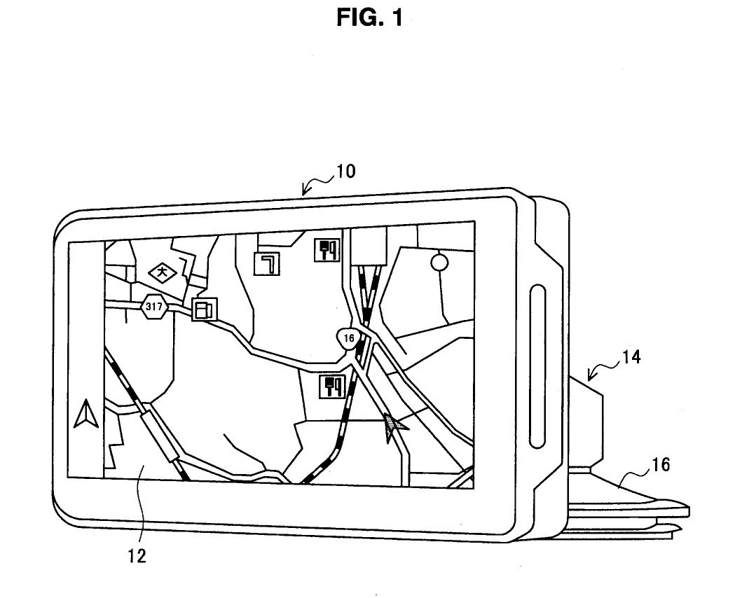

Heretofore, the object of the present embodiments has been described. Next, with reference to FIGS. 1 to 9, a navigation device according to a first embodiment will be described. In the present embodiment, a PND (Personal Navigation Device) 10 shown in FIG. 1 will be applied to the navigation device and described.

### <2-1. Hardware Configuration of PND>

First, with reference to FIG. 1, a hardware configuration of the PND 10 will be described. As shown in FIG. 1, a display section 12 is provided on the front surface of the PND 10. The PND 10 displays an actual image or the like corresponding to map data, which is stored in a built-in non-volatile memory (not shown), on the display section 12, and executes navigation. Further, the PND 10 may include a cradle 14 and a suction cup 16. The cradle 14 and the suction cup 16 are necessary when the PND 10 is used in a vehicle in order to attach the PND 10 to a dashboard of the vehicle. The PND 10 is attached to the dashboard of the vehicle via the suction cup 16, and is mechanically and electrically connected thereto. The PND 10 is capable of operating by power supplied from the vehicle via the cradle 14.

In the case of using the PND 10 when the user travels on foot, the PND 10 may not have the cradle 14 and the suction cup 16. In the case of using the PND 10 when the user travels on foot, the user travels by carrying only the main body of the PND 10. In the case of using the PND 10 when the user travels by bicycle, the user may travel by carrying only the main body of the PND 10 in the same manner as in the case of travelling on foot, or may travel by attaching the cradle 14 and the suction cup 16 to a handle or the like of the bicycle, thereby attaching thereto the PND 10.

Further, a desired navigation mode can be selected from multiple navigation modes by pressing a navigation mode-switching button (not shown) of the PND 10. For example, a car mode is selected in the case of using the PND 10 in a car, a bicycle mode is selected in the case of using the PND 10 on a bicycle, and a pedestrian mode is selected in the case of using the PND 10 for walking.

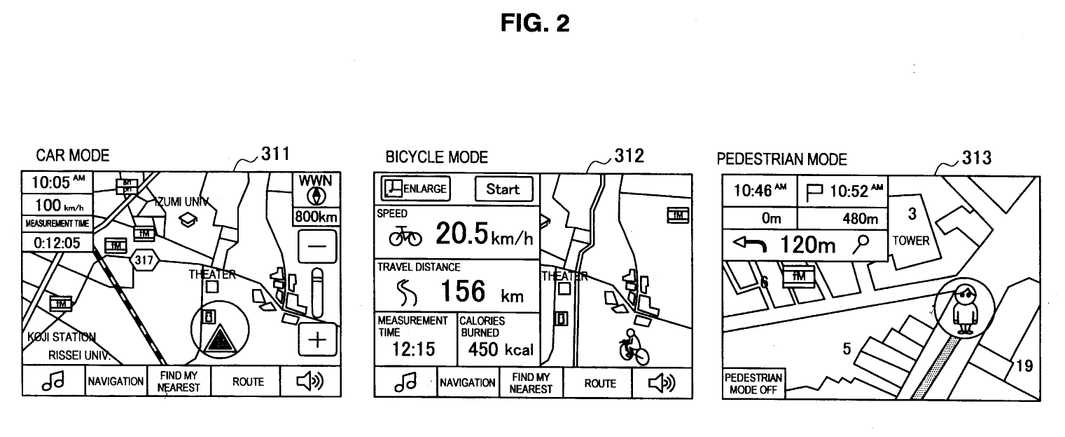

As shown in FIG. 2, in a display screen of the PND 10, a map display and a mark indicating a current position are changed depending on respective navigation modes. For example, a display example 311 is a display example when the navigation is performed in the car mode, and the navigation is performed by displaying a large area map. Further, a display example 312 is a display example when the navigation is performed in the bicycle mode, and the navigation is performed by displaying a map of an area smaller than the area used in the car mode. Still further, a display example 313 is a display example when the navigation is performed in the pedestrian mode, and the navigation is performed by displaying a map of an area which is still smaller than the area used in the bicycle mode.

Further, in the car mode, the current position is displayed by a triangle, in the bicycle mode, the current position is displayed by a bicycle mark, and in the pedestrian mode, the current position is displayed by a human-shaped mark. Although FIG. 2 shows the display examples in the case where the navigation is executed in the car mode, the bicycle mode, and the pedestrian mode, the examples are not limited thereto, and can be applied to other navigation modes such as a motorcycle mode and a jogging mode. The user presses a navigation mode-switching button or the like of the navigation device, and hence, it becomes possible to select a desired navigation mode from multiple navigation modes.

When the navigation mode which the user desires is selected by the operation of the user, the PND 10 executes navigation in the selected navigation mode. Because the PND 10 has a function of acquiring the current position, the PND 10 displays a map including the current position on the display section 12, and executes navigation in a manner that a current position and a travelling direction of the user are superimposed on the map.

In addition, the PND 10 can register an appropriate stopping point by detecting which of the navigation modes is selected. For example, in the case where the navigation mode is switched from the car mode to the pedestrian mode, the PND 10 determines that the user stops the car and starts walking, and can set the point at which the navigation modes are switched as a stopping point. Further, in the case where the navigation mode is switched from the pedestrian mode to the car mode, the PND 10 determines that the user stops walking and gets into a car, and can also set the point at which the navigation modes are switched as a stopping point. In this way, in the present embodiment, it becomes possible to register the appropriate stopping point in response to the switching of the navigation modes.

### <2-2. Functional Configuration of PND>

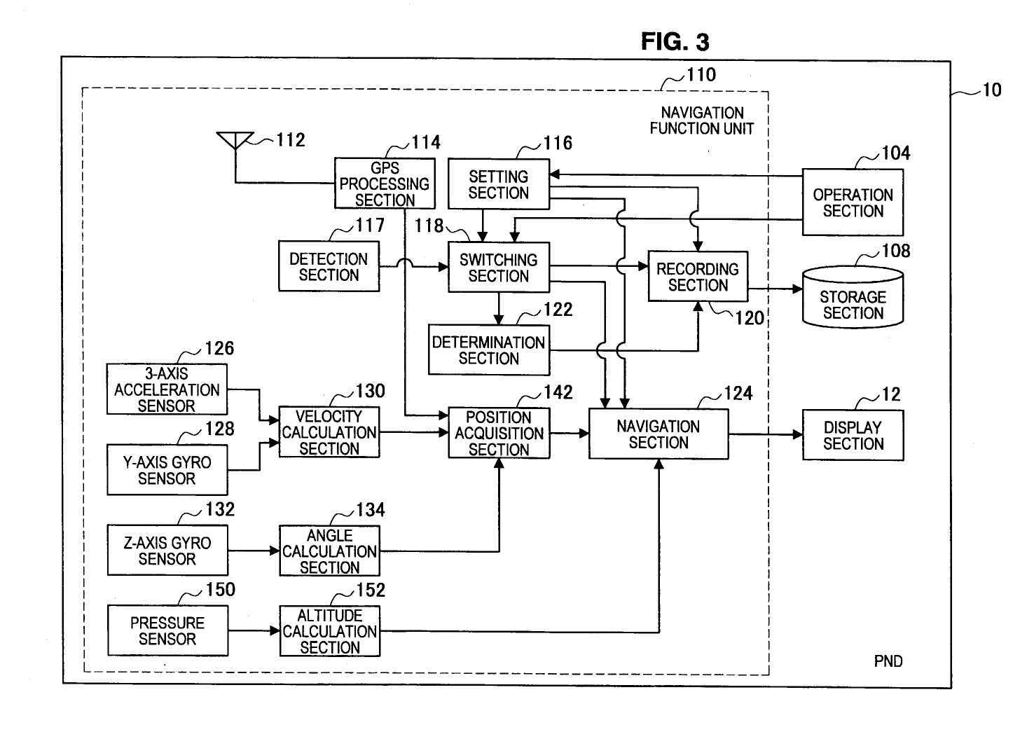

Heretofore, the hardware configuration of the PND 10 has been described. Next, with reference to FIG. 3, a functional configuration of the PND 10 will be described. As shown in FIG. 3, the PND 10 includes the display section 12, an operation section 104, a storage section 108, a navigation function unit 110, and the like.

The operation section 104 detects operation of the user and outputs the detected operation contents to the navigation function unit 110. As the user's operation contents, there can be exemplified selecting a navigation mode, setting of a destination, enlarging/reducing the scale of a map, displaying a current position, setting of vocal guidance, and setting of screen display.

Further, the operation section 104 may be a touch panel or a touch screen which is provided in an integrated manner with the display section 12. Further, the operation section 104 may have a physical configuration such as a button, a switch, a lever, or a dial, which is provided separately from the display section 12. Still further, the operation section 104 may be a signal reception section which detects a signal indicating the operation of the user transmitted from a remote controller.

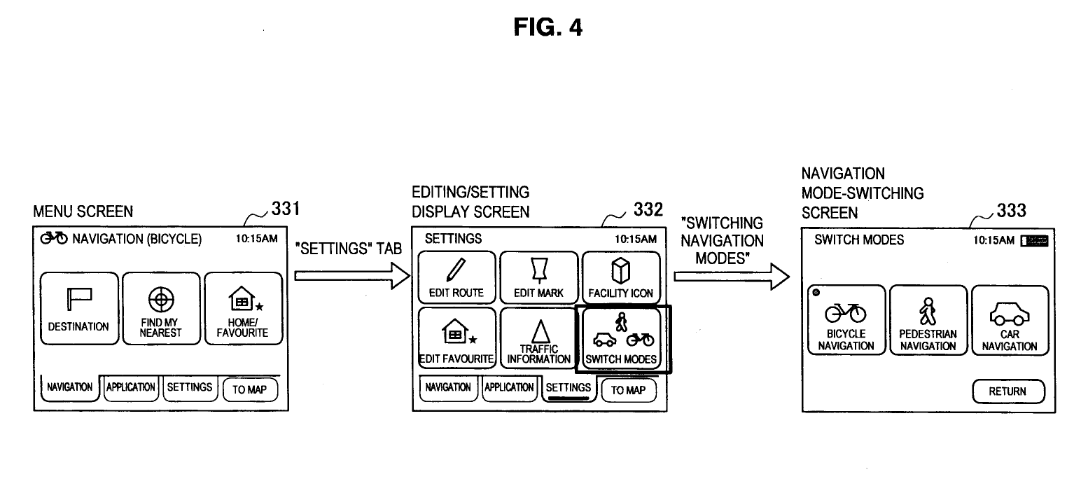

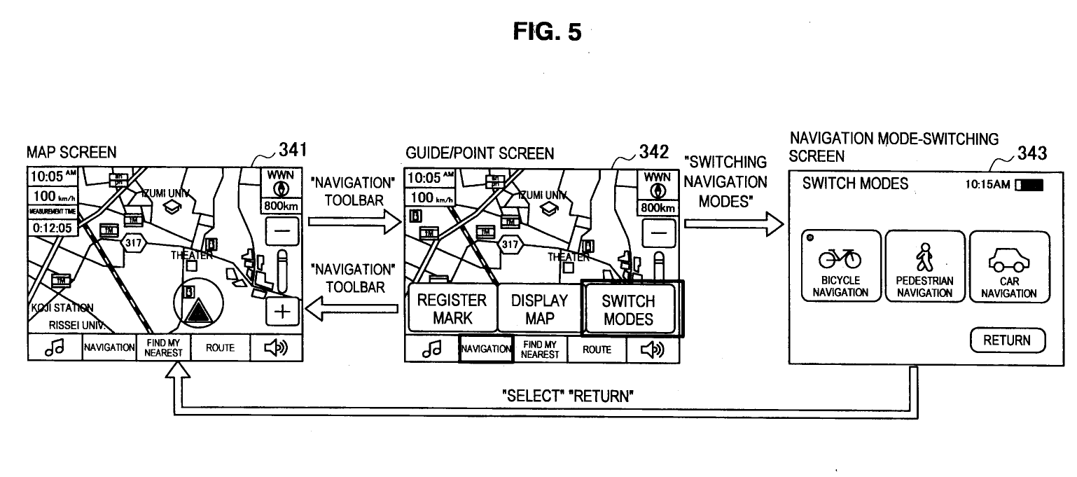

Here, with reference to FIGS. 4 and 5, the selection operation of a navigation mode by the user will be described. FIGS. 4 and 5 are each an explanatory diagram illustrating selection operation of a navigation mode. In FIGS. 4 and 5, a description will be made of the case where the operation section 104 is a touch panel provided in an integrated manner with the display section 12.

As shown in FIG. 4, the user selects a “settings” tab from among display items in a menu screen 331 displayed on the touch panel. When the “settings” tab is selected, an editing/setting display screen 332 is displayed. Then, when the user touches a “switch modes” button, a navigation mode-switching screen 333, which can switch between navigation modes, is displayed. The user can select a desired navigation mode by touching any one of the mode buttons of “car navigation” (car mode), “bicycle navigation” (bicycle mode), and “pedestrian navigation” (pedestrian mode), which are displayed on the navigation mode-switching screen 333.

Further, as shown in FIG. 5, in the case where navigation is being executed, the navigation mode in execution may be switched to another navigation mode. As shown in FIG. 5, in the case where the navigation is being executed in the car mode, a “navigation” toolbar displayed on a map screen 341 of the car mode is selected. When the “navigation” toolbar is selected, a guide/point screen 342 is displayed.

The user touches a “switch modes” button displayed on the guide/point screen 342. When the “switch modes” button of the guide/point screen 342 is touched, a navigation mode-switching screen 343 is displayed. The user can select a desired navigation mode by touching any one of the mode buttons of “car navigation” (car mode), “bicycle navigation” (bicycle mode), and “pedestrian navigation” (pedestrian mode), which are displayed on the navigation mode-switching screen 343.

Returning to FIG. 3, the description of the functional configuration of the PND 10 will be continued. The storage section 108 stores a program for the PND 10 to operate, configuration information specific to each navigation mode, and the like. Examples of the configuration information specific to each navigation mode include a guidance notification method, map data, volume data, screen brightness data, and the like, each corresponding to a navigation mode.

Further, a recording section 120, which will be described later, stores position information of a switching point at which a navigation mode is switched to another navigation mode and a destination set by the user in association with each other. Further, the recording section 120 may store the switching point-position information as stopping point-information, and may store the number of times stopped at the stopping point. In addition, multiple stopping points may be stored with respect to one destination.

Note that, the storage section 108 may be a storage medium such as a non-volatile memory, a magnetic disk, an optical disk, and an MO (Magneto Optical) disk. Examples of the non-volatile memory include an EEPROM (Electrically Erasable Programmable Read-Only Memory) and an EPROM (Erasable Programmable ROM). Examples of the magnetic disk include a hard disk and disc-like magnetic disk. Further, examples of the optical disk include a CD (Compact Disc), a DVD-R (Digital Versatile Disc Recordable), and a BD (Blu-Ray Disc (registered trademark)).

The navigation function unit 110 is a configuration for realizing a navigation function, and mainly includes a GPS antenna 112, a GPS processing section 114, a setting section 116, a detection section 117, a switching section 118, a recording section 120, a determination section 122, a navigation section 124, a 3-axis acceleration sensor 126, a Y-axis gyro sensor 128, a velocity calculation section 130, an X-axis gyro sensor 132, an angle calculation section 134, a position acquisition section 142, a pressure sensor 150, and an altitude calculation section 152.

Of those, the GPS processing section 114, the setting section 116, the detection section 117, the switching section 118, the recording section 120, the determination section 122, the navigation section 124, the angle calculation section 134, the position acquisition section 142, the altitude calculation section 152, and the like are configured from a CPU (Central Processing Unit), for example.

The GPS antenna 112 receives GPS signals transmitted from artificial satellites which circle above the Earth, and supplies the GPS processing section 114 with the received GPS signals. Note that the GPS signals include orbital information indicating orbits of the artificial satellites and information such as transmission time of the signals.

The GPS processing section 114 calculates a position of each of the artificial satellites based on the orbital information included in each GPS signal. Then, the GPS processing section 114 calculates a current three-dimensional position by simultaneous equations based on the position of each artificial satellite and a difference between a transmission time and a reception time of the GPS signal.

The setting section 116 has a function of setting a destination in accordance with operation of the user. The user can set a desired destination by operating the operation section 104. The switching section 118 has a function of switching between navigation modes in accordance with the operation of the user. As described above, a navigation mode is selected by the user via the operation section 104.

The detection section 117 has a function of detecting whether or not the main body of the PND 10 is mounted on a car. Whether or not the main body is mounted on the car can be detected based on whether or not the main body is attached to a cradle (base part), for example. As described above, in the case where the PND 10 is attached to the cradle, the PND 10 is supplied with electricity from the vehicle via the cradle. Therefore, it becomes possible that the detection section 117 detects whether or not the main body is attached to the cradle by determining whether or not the main body is supplied with electricity via the cradle. Further, whether or not the main body of the PND 10 is mounted on the car may be detected based on vibrations of the main body of the PND 10.

In the case where another navigation mode, which is different from the current navigation mode, is selected by the user via the operation section 104, the switching section 118 switches the navigation mode to the selected navigation mode. The switching section 118 notifies the recording section 120 and the determination section 122 that which of the navigation modes the switching section 118 switches the navigation mode to. Further, in the case where the detection section 117 detects that the main body of the PND 10 is attached to the cradle, the switching section 118 may switch the navigation mode to the car mode. Further, in the case where the detection section 117 detects that the main body of the PND 10 is detached from the cradle, the switching section 118 may switch the navigation mode from the car mode to the pedestrian mode.

The recording section 120 has a function of recording, in the storage section 108, position information of a switching point at which a navigation mode is switched to another navigation mode by the switching section 118 and a destination set by the setting section 116 in association with each other. For example, in the case where the navigation mode is switched from the car mode to the pedestrian mode by the switching section 118, the recording section 120 records, in the storage section 108, the position information of the switching point at which the navigation mode is switched from the car mode to the pedestrian mode and the destination in association with each other. Further, in the case of switching from the pedestrian mode to the car mode, the position information of the switching point and the destination may be recorded in association with each other in the storage section 108.

In the case where the navigation mode is switched from the car mode to the pedestrian mode by the switching section 118, it can be determined that the user stops the car at the point at which the navigation modes are switched, and starts walking. By recording the position information of the switching point and the destination in the recording section 120, it becomes possible to record the point at which the car is stopped before arriving at the destination, and to learn a stopping point such as a car park.

The determination section 122 has a function of determining whether or not there is a road in the vicinity of the switching point at which navigation modes are switched by the switching section 118. The determination section 122 determines that there is a road in the vicinity of the switching point in the case where there is a road network within a predetermined range. For example, in the case where there is no road network within 50 m range from the switching point, the determination section 122 may determine that there is no road in the vicinity.

Further, even in the case where there is a road network within a predetermined range from the switching point, when an azimuth of the road network and a current azimuth greatly differ from each other, for example, when the difference therebetween is 40 degrees or more, it may be determined that there is no road in the vicinity. Information related to the road network may be stored in the storage section 108 or may be acquired from a server or the like which holds map information via a network.

Further, in the case where it is determined by the determination section 122 that there is no road in the vicinity of the switching point, the recording section 120 may record, in the storage section 108, the position information of the switching point and the destination in association with each other. In the case where the position information of the switching point and the destination are recorded as mentioned above, the recording section 120 learns, even in the case of stopping on a road, the point on the road as the stopping point. As described above, by determining by the determination section 122 whether or not the switching point is a point at which there is a road network, it becomes possible not to record the stopping point in the case of stopping on a road.

In the recording section 120, the latitude and the longitude of the switching point are recorded as the position information of the switching point. Further, in addition to the position information of the switching point, there may also be registered the number of times the switching point is recorded by the recording section 120. By recording the number of times the switching point is recorded, the number of stopping times at the stopping point can be found out, and a frequently-stopped point can be grasped.

The navigation section 124 has a function of showing a route to the destination set by the setting section 116 by using position information acquired by the position acquisition section 142 which will be described later. Further, the navigation section 124 performs navigation depending on a navigation mode switched by the switching section 118. For example, the navigation section 124 reads out map data corresponding to the navigation mode from the storage section 108, and superimposes a current position mark on a map image including a current position. The navigation section 124 is an example of a guidance section according to the embodiment of the present invention.

Further, in the case where a destination which the user desires is set by the setting section 116, the navigation section 124 may lead the way to a stopping point associated with the destination in the car mode, and may lead the way from the stopping point to the destination in the pedestrian mode. Further, in the case where multiple stopping points are associated with the destination set by the setting section 116, the navigation section 124 may preferentially lead the way to the stopping point whose number of times stopped is large, or may lead the way to the stopping point selected by the user.

In the case where it is difficult for the GPS antenna 112 to receive the GPS signals from the artificial satellites, it may be impossible for the GPS processing section 114 to calculate the current position based on the GPS signals. In such a case, the navigation section 124 performs navigation by using a current position acquired by another method. For example, the navigation section 124 is capable of performing navigation by using a current position obtained by the following sensors and calculation sections.

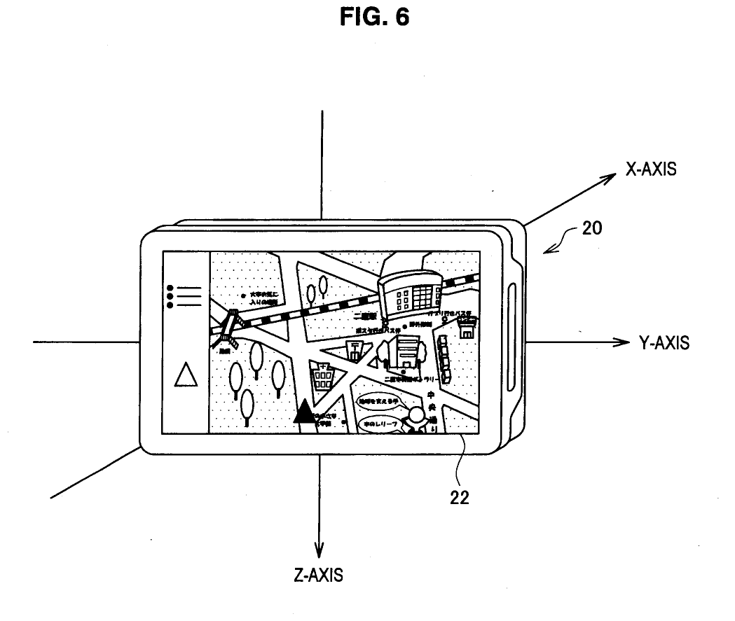

The 3-axis acceleration sensor 126 detects an acceleration rate αx along the X-axis, an acceleration rate αy along the Y-axis, and an acceleration rate αz along the Z-axis, which are shown in FIG. 6, at a sampling frequency of 50 Hz, for example. Note that, as shown in FIG. 6, the X-axis corresponds to a travelling direction of the PND 10 or the vehicle, the Y-axis corresponds to the horizontal direction that is perpendicular to the X-axis, and the Z-axis corresponds to the vertical direction.

The Y-axis gyro sensor 128 detects a pitch rate ωy, which is an angular velocity around the Y-axis, at a sampling frequency of 50 Hz, for example.

The velocity calculation section 130 calculates a velocity V in the travelling direction 50 times per second, for example, in accordance with the following Equation 1, based on the acceleration rate αz along the Z-axis detected by the 3-axis acceleration sensor 126 and the pitch rate ωy detected by the Y-axis gyro sensor 128.

$$\begin{matrix}[ Equation 1 ] & \\ V = \frac{{α}_{z}}{{ω}_{y}} & ( Equation 1 )\end{matrix}$$

The X-axis gyro sensor 132 detects a yaw rate ωz, which is an angular velocity around the Z-axis when the PND 10 or the vehicle is turning counter-clockwise, at a sampling frequency of 50 Hz, for example.

The angle calculation section 134 calculates a turning angle θ of the PND 10 or the vehicle by multiplying the yaw rate ωz detected by the X-axis gyro sensor 132 by a sampling frequency (for example, 0.02 s).

The position acquisition section 142 calculates an amount of change from the position at the previous calculation to the current position based on the velocity V in the travelling direction calculated by the velocity calculation section 130 and the turning angle θ calculated by the angle calculation section 134. Then, the position acquisition section 142 acquires the current position by adding the amount of change to the position at the previous calculation. Further, in the case where current position information is calculated by the GPS processing section 114, the position acquisition section 142 acquires the position information. The position acquisition section 142 is an example of an acquisition section according to the embodiment of the present invention.

The pressure sensor 150 detects the surrounding pressure at a sampling frequency of 50 Hz, for example. Then, the altitude calculation section 152 calculates a current altitude based on the pressure detected by the pressure sensor 150.

The navigation section 124 can perform navigation as described above, based on the current position calculated by the position acquisition section 142 and the current altitude calculated by the altitude calculation section 152.

Note that the method of acquiring the current position and the like is not limited to the above method involving using the GPS measurement and sensors. For example, the current position can be acquired by using signal strength of WiFi radio waves transmitted from wireless LAN base stations. More specifically, the PND 10 estimates distances from the respective base stations based on the reception strength of the WiFi radio waves, and acquires a current position based on the triangulation principle using the distances from the respective base stations and the positions of the respective base stations.

### <2-3. Details of Operation of PND>

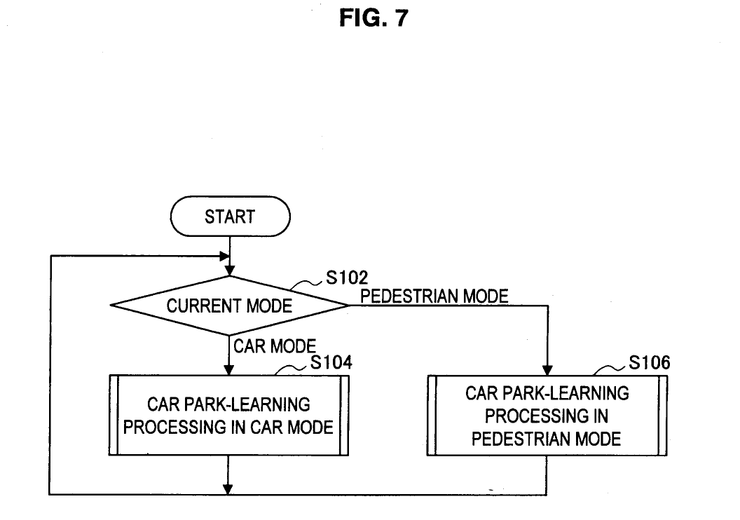

Heretofore, the functional configuration of the PND 10 has been described. Next, with reference to FIGS. 7 to 10, the details of operation of the PND 10 according to the present embodiment will be described. FIG. 7 is a flowchart showing processing of learning a stopping point of the PND 10 according to the present embodiment. Hereinafter the description will be given by using a car park as a stopping point.

As shown in FIG. 7, first, it is determined which of the modes represents the current mode (S102). In Step S102, which of the modes represents the current mode can be determined by determining whether or not it is detected that the main body is attached to the cradle or whether or not a mode is switched to another mode by operation of the user.

In the case where it is determined in Step S102 that the current mode is the car mode, car park-learning processing in car mode is executed (S104). The car park-learning processing in car mode of Step S104 will be described later in detail. In the case where it is determined in Step S102 that the current mode is the pedestrian mode, car park-learning processing in pedestrian mode is executed (S106). The car park-learning processing in pedestrian mode of Step S106 will be described later in detail.

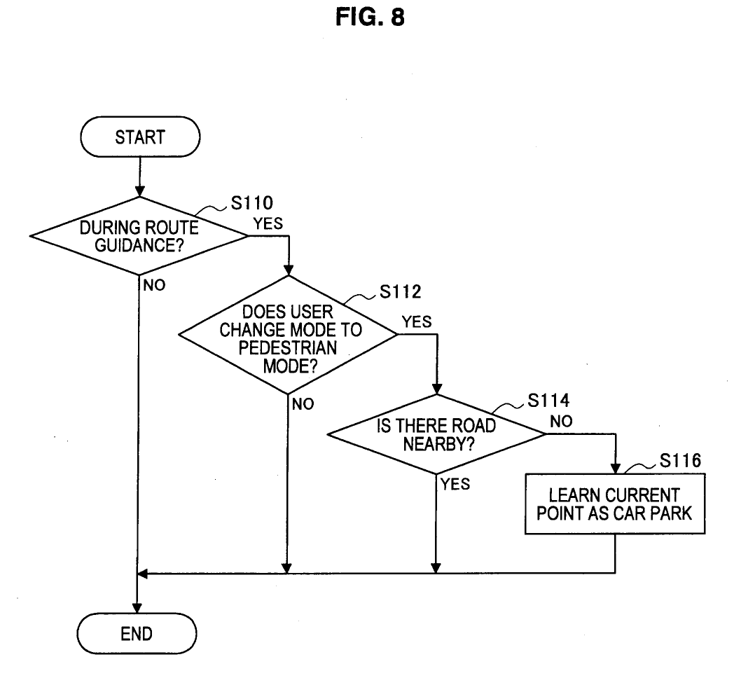

Next, with reference to FIG. 8, the car park-learning processing in car mode of Step S104 in FIG. 7 will be described. As shown in FIG. 8, first, whether or not it is during route guidance by the navigation section 124 is determined (S110). “During route guidance” in Step S110 indicates that it is in the middle of performing the guidance of the route to the destination set by the user.

In the case where it is determined in Step S110 that it is during route guidance, whether or not the user changes the mode from the car mode to the pedestrian mode is determined (S112). In Step S112, it is determined whether or not the navigation mode is switched from the car mode to the pedestrian mode by operation of the user. Further, in the case where the main body of the PND 10 installed in the cradle is detached from the cradle, it may be determined that the navigation mode is changed from the car mode to the pedestrian mode. In the case where it is determined in Step S110 that it is not during route guidance, the processing is terminated.

In Step S112, whether or not the user changes the mode to the pedestrian mode is determined. In the case where it is determined in Step S112 that the user changes the mode to the pedestrian mode, then, whether or not there is a road in the vicinity of a point at which the mode is changed to the pedestrian mode is determined (S114). In Step S114, it is determined that there is a road in the vicinity in the case where there is a road network within a predetermined range from the point at which the mode is changed. Further, in the case where there is a road network within a range of 50 m from the point at which the mode is changed, it may be determined that there is a road in the vicinity. Still further, it may be determined that there is a road in the vicinity, in the case where there is a road network in the vicinity and an azimuth of the road network and a current azimuth are the same.

In the case where it is determined in Step S112 that the user does not change the mode to the pedestrian mode, the processing is terminated. In the case where it is determined in Step S114 that there is no road in the vicinity of the point at which the navigation mode is changed, the PND 10 learns the current point as a car park (S116). In the case where it is determined in Step S114 that there is a road in the vicinity of the point at which the navigation mode is changed, the processing is terminated.

To learn the current point as a car park in Step S116 means to store position information of a point at which the user changed the mode to the pedestrian mode and an original destination set by the user in association with each other. Thus it becomes possible to learn the position stopped before arriving at the destination as a car park. Further, in the case where the position information of the stopping position is already stored as a car park, the number of times stopped at the car park may be stored. Thus, in the case where there multiple car parks are set for one destination, it can be found out which of the car parks is the most frequently stopped car park.

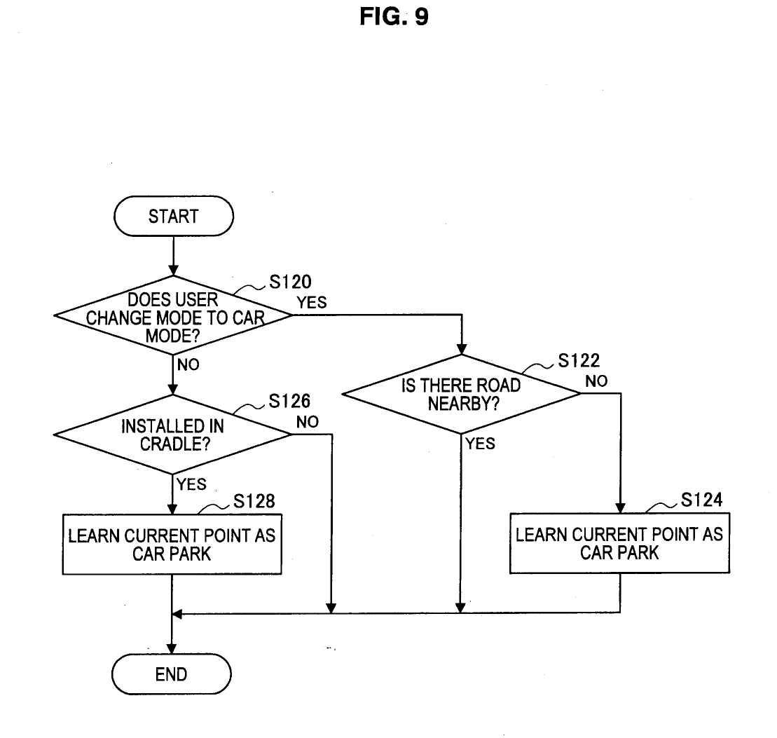

Heretofore, the car park-learning processing in car mode has been described. Next, with reference to FIG. 9, the car park-learning processing in pedestrian mode of Step S106 in FIG. 7 will be described. As shown in FIG. 9, whether or not the user changes the mode to the car mode is determined (S120). In Step S120, it is determined whether or not the navigation mode is switched from the pedestrian mode to the car mode by operation of the user.

In the case where it is determined in Step S120 that the user changes the mode from the pedestrian mode to the car mode, then, whether or not there is a road in the vicinity of a point at which the mode is changed to the car mode (S122). Then, in the case where it is determined in Step S122 that there is no road in the vicinity of the point at which the mode is changed to the car mode, the PND 10 learns the point at which the mode is changed to the car mode as a car park (S124). Since the processing of Step S122 and the processing of Step S124 are the same as the processing of Step S114 in FIG. 8 and the processing of Step S116 in FIG. 8, respectively, the detailed description thereof will be omitted.

Further, in the case where it is determined in Step S120 that the user does not change the mode to the car mode, then, whether or not the main body of the PND 10 is installed in the cradle is determined (S126). In Step S126, it may be determined that the main body of the PND 10 is installed in the cradle when the main body of the PND 10 is supplied with electricity via the cradle.

In the case where it is determined in Step S126 that the main body of the PND 10 is installed in the cradle, the PND 10 learns the current point as a car park (S128). To learn the point at which the navigation mode is changed from the pedestrian mode to the car mode as the car park in Step S124 and Step S128 means, as described above, to store position information of a point at which the navigation mode is changed and a destination set by the user in association with each other. Thus it becomes possible, when the destination is set by the user, to show a route to the stopping point (car park) associated with the destination. In this way, it becomes possible to lead the way to a car park which is in the vicinity of the destination appropriately.

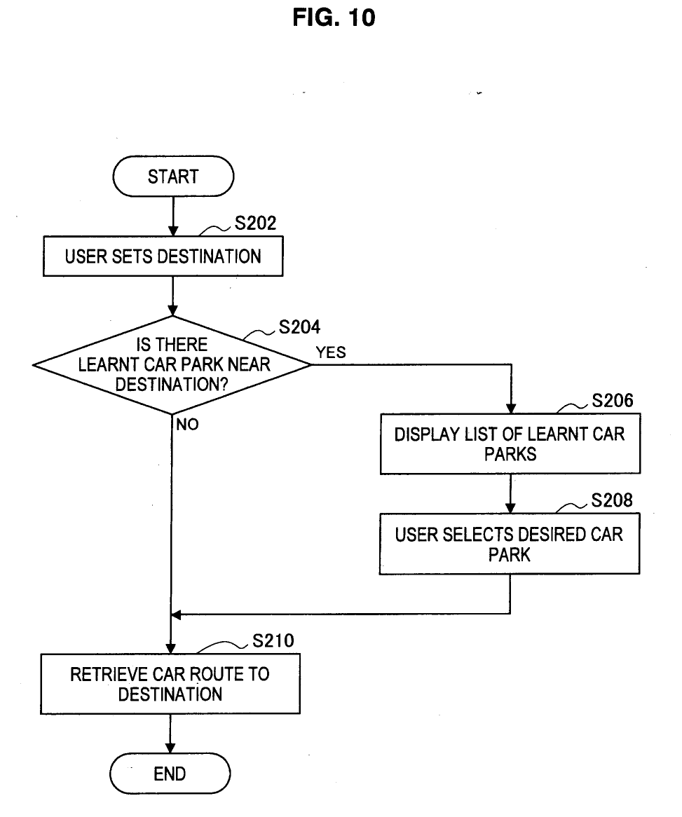

Next, there will be described cases of performing route guidance by using the car parks learnt in FIGS. 7 to 9. FIG. 10 is a flowchart showing route guidance processing in the case of departing in the car mode. As shown in FIG. 10, first, a destination is set by the user (S202). Then, it is determined whether or not there is the learnt car park in the vicinity of the destination set by the user in Step S202 (S204).

In Step S204, whether or not there is the learnt car park is determined based on whether or not a stopping point associated with the destination which is set in Step S202 is stored. In the case where it is determined in Step S204 that there is the learnt car park in the vicinity of the destination, a list of the learnt car parks is displayed (S206). In Step S206, in the case where there are multiple stopping points which are stored in association with the destination, a list of multiple stopping points is displayed.

Further, in displaying the list of car parks in Step S206, the list may be displayed in accordance with the number of times stopped at each car park. For example, the car parks may be displayed in order of descending number of times stopped. In this way, it becomes possible to preferentially display a frequently-stopped car park. In the case where it is determined in Step S204 that there is no learnt car park in the vicinity of the destination, the processing of Step S210 is executed.

After that, a car park desired by the user is selected from the car parks displayed in the list (S208). Then, a car route to the destination is retrieved (S210). In Step S210, in the case where a desired car park is selected by the user, a route is retrieved by setting the car park as a destination.

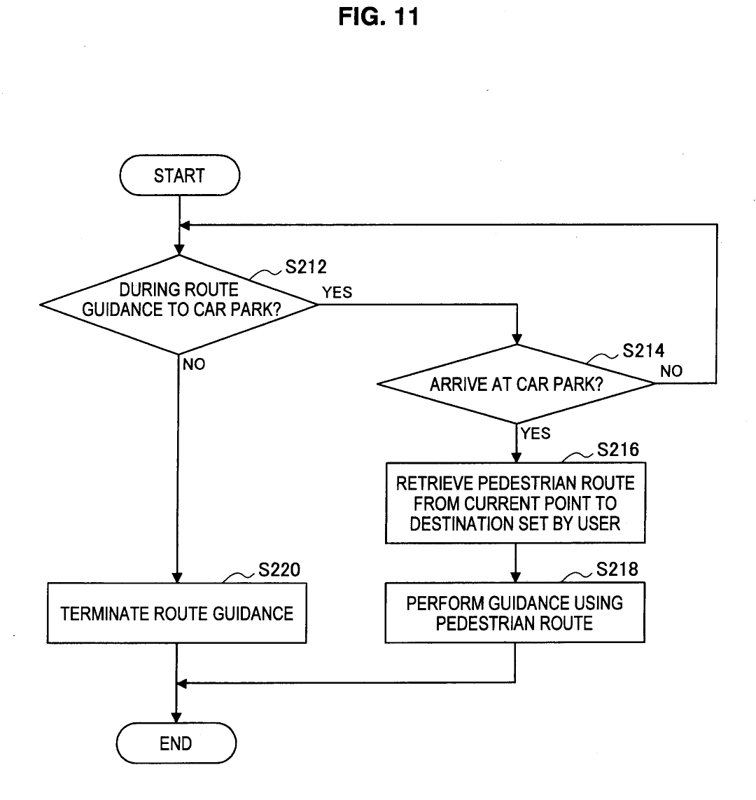

Next, there will be described route guidance in the case of arriving at a car park as the destination. FIG. 11 is a flowchart showing route guidance in the case of arriving at the car park as the destination. First, whether or not it is during route guidance to the car park is determined (S212). In the case where it is determined in Step S212 that it is during route guidance to the car park, then, whether or not the car arrives at the car park is determined (S214). In Step S214, in the case where the car stops when a distance between the current point and the destination is within a predetermined range (for example, within 100 m), it may be determined that the car arrives at the car park.

In the case where it is determined in Step S214 that the car arrives at the car park, a pedestrian route from a current point to a destination set by the user is retrieved (S216). The destination in Step S216 is an original destination initially set by the user at the start. In the case where it is determined in Step S214 that the car does not arrive at the car park, the processing returns to Step S212. Then, guidance using the pedestrian route is performed (S218).

On the other hand, in the case where it is determined in Step S212 that it is not during route guidance to the car park, route guidance to the destination is performed continuously, and in the case where the route guidance is terminated (S220), the processing is terminated. Heretofore, the route guidance in the case of arriving at a car park as the destination has been described.

According to the embodiment described above, the position information of the point at which the navigation mode is switched from the car mode to the pedestrian mode or the point at which the navigation mode is switched from the pedestrian mode to the car mode and the destination can be stored in the storage section 108 in association with each other. In this way, the switching point of the navigation modes can be recorded as a stopping point, and hence, it becomes possible to register an appropriate stopping point regardless of stoppage time. Further, in the case where information of the registered stopping point with respect to the set destination is recorded, it becomes possible to show the stopping point to the user. In addition, since the route guidance to a stopping point such as a car park can be performed only by setting a destination by the user, it becomes possible to automatically lead the user to the appropriate stopping point without registering nor searching for a car park beforehand. Heretofore, the first embodiment has been described.

### 3. Second Embodiment

The PND 10 described in the first embodiment is merely an example of the navigation device, and the navigation device is not limited thereto. For example, the navigation device may be a mobile phone 20, which will be described as a second embodiment below. In addition, although the detailed description will be omitted, the navigation device may be a PHS, a portable music reproduction device, a portable video processing device, a portable game device, a portable imaging device, and the like.

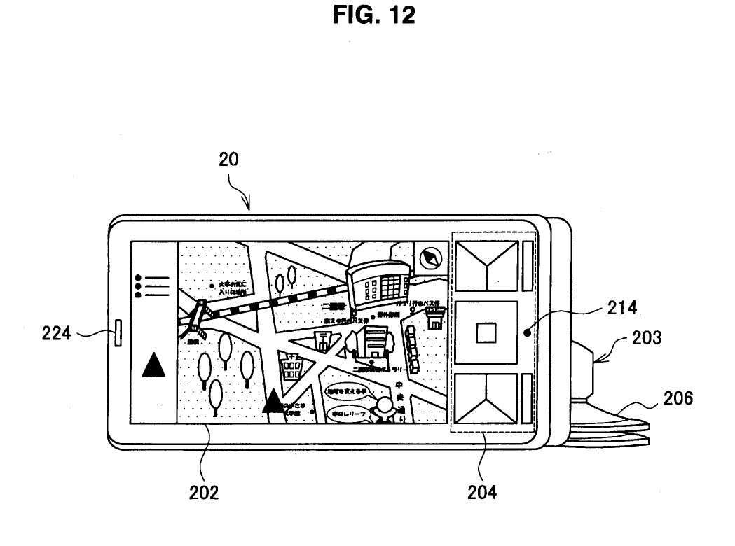

FIG. 12 is an external view of the mobile phone 20 according to the second embodiment. As shown in FIG. 12, the mobile phone 20 according to the second embodiment includes a display section 202, a cradle 203, an operation section 204, a suction cup 206, a microphone 214, and a speaker 224.

In the same manner as the PND 10 according to the first embodiment, the cradle 203 is attached to a dashboard of a vehicle via the suction cup 206, and is mechanically and electrically connected to the mobile phone 20. Therefore, the mobile phone 20 is capable of operating by power supplied from the vehicle via the cradle 203. Note that the mobile phone 20 has a built-in battery, and, when detached from the cradle 203, the mobile phone 20 is capable of operating by power supplied from the battery.

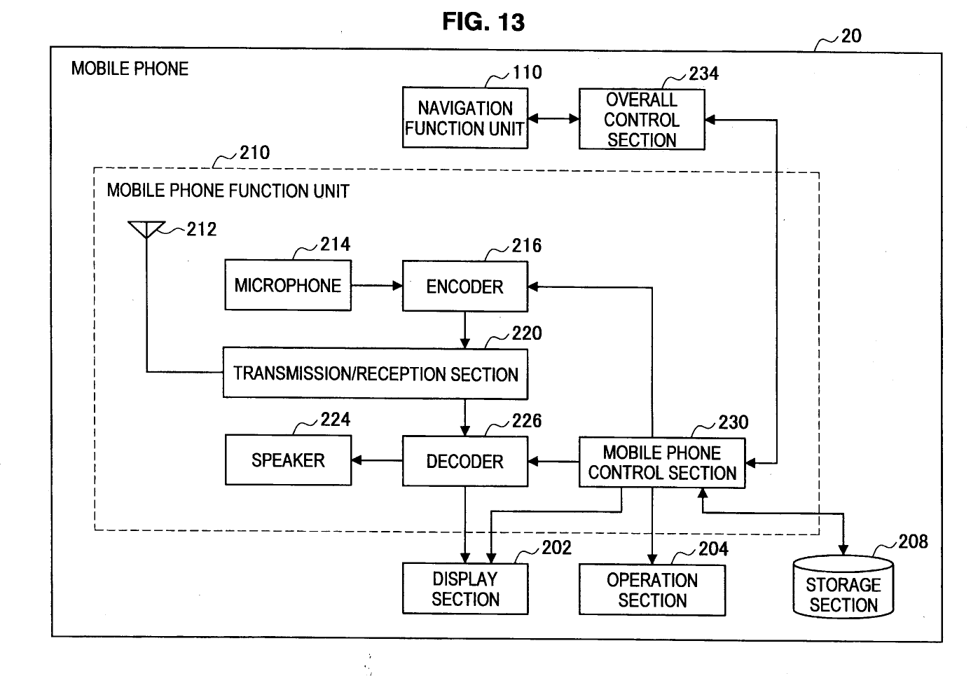

FIG. 13 is a functional block diagram showing a configuration of the mobile phone 20 according to the second embodiment. As shown in FIG. 13, the mobile phone 20 according to the second embodiment includes a navigation function unit 110, a display section 202, an operation section 204, a storage section 208, a mobile phone function unit 210, and an overall control section 234.

Further, the mobile phone function unit 210 has a configuration for realizing a verbal communication function and an e-mail function, and includes a communication antenna 212, the microphone 214, an encoder 216, a transmission/reception section 220, the speaker 224, a decoder 226, and a mobile phone control section 230. Note that, since the detailed configuration of the navigation function unit 110 has been described in the first embodiment, the detailed description thereof will be omitted.

The microphone 214 collects sound and outputs the sound as an audio signal. The encoder 216 performs digital conversion and encoding of the audio signal input from the microphone 214 in accordance with the control of the mobile phone control section 230, and outputs audio data to the transmission/reception section 220.

The transmission/reception section 220 modulates the audio data input from the encoder 216 in accordance with a predetermined system, and transmits the modulated audio data to a base station of the mobile phone 20 from the communication antenna 212 via radio waves. Further, the transmission/reception section 220 demodulates a radio signal received by the communication antenna 212 and acquires audio data, and outputs the audio data to the decoder 226.

The decoder 226 performs decoding and analog conversion of the audio data input from the transmission/reception section 220 in accordance with the control of the mobile phone control section 230, and outputs an audio signal to the speaker 224. The speaker 224 outputs the audio based on the audio signal supplied from the decoder 226.

Further, in the case of receiving an e-mail, the mobile phone control section 230 supplies the decoder 226 with received data from the transmission/reception section 220, and causes the decoder 226 to decode the received data. Then, the mobile phone control section 230 outputs e-mail data obtained by the decoding to the display section 202 and causes the display section 202 to display the e-mail data, and also records the e-mail data in the storage section 208.

Further, in the case of transmitting an e-mail, the mobile phone control section 230 causes the encoder 216 to encode the e-mail data which is input via the operation section 204, and transmits the encoded e-mail data via radio waves through the transmission/reception section 220 and the communication antenna 212.

The overall control section 234 controls the mobile phone function unit 210 and the navigation function unit 110. For example, in the case of receiving a phone call while the navigation function unit 110 is executing a navigation function, the overall control section 234 may temporarily switch its function from the navigation to a verbal communication by the mobile phone function unit 210, and, when the call ends, may cause the navigation function unit 110 to restart the navigation function.

It should be understood by those skilled in the art that various modifications, combinations, sub-combinations and alterations may occur depending on design requirements and other factors insofar as they are within the scope of the appended claims or the equivalents thereof.

For example, in the embodiments above, a point at which the mode is changed from the car mode to the pedestrian mode is registered as a stopping point such as a car park, but the examples are not limited thereto. For example, a point at which the mode is changed from a bicycle mode or a motorcycle mode to the pedestrian mode may be registered as a stopping point such as a bicycle parking area. In the case of leading the way to the stopping point such as the bicycle parking area in bicycle mode, a route which can be traveled on by a bicycle can be shown.

For example, the respective steps of processing in the navigation device such as the PND 10 and the mobile phone 20 may not necessarily be processed chronologically in accordance with the stated order in the flowcharts. For example, the respective steps of the processing in the navigation device such as the PND 10 and the mobile phone 20 may be processed in different order from the order stated in the flowcharts or may be processed in a parallel manner.

Further, a computer program can be produced, which is for causing hardware such as a CPU, a ROM, and a RAM built in the navigation device such as the PND 10 and the mobile phone 20 to exhibit functions equivalent to the functions of respective configurations of the navigation device. Further, there is also provided a storage medium which stores the computer program.

The present application contains subject matter related to that disclosed in Japanese Priority Patent Application JP 2010-037467 filed in the Japan Patent Office on Feb. 23, 2010, the entire content of which is hereby incorporated by reference.

What is claimed is:

1. A navigation device comprising:
an acquisition section which acquires position information;
a setting section which sets a destination in accordance with operation of a user;
a guidance section which shows a route to the destination by using the position information;
a switching section which switches a navigation mode to another navigation mode in accordance with operation of a user; and
a recording section which records position information of a switching point at which navigation modes are switched by the switching section and the destination in association with each other.

2. The navigation device according to claim 1,
wherein, when the destination is set by the setting section, the guidance section shows a route to the switching point associated with the destination in one navigation mode, and shows a route from the switching point to the destination in another navigation mode.

3. The navigation device according to claim 1, further comprising
a determination section which determines whether or not there is a road in a vicinity of the switching point,
wherein, when the determination section determines that there is no road in the vicinity of the switching point, the recording section records the position information of the switching point and the destination in association with each other.

4. The navigation device according to claim 3,
wherein the determination section determines that there is a road in the vicinity of the switching point when there is a road network within a predetermined range from the switching point.

5. The navigation device according to claim 1,
wherein the navigation mode includes a car mode, a motorcycle mode, a bicycle mode, and a pedestrian mode.

6. The navigation device according to claim 5,
wherein, when the car mode is switched to the pedestrian mode by the switching section, the recording section records position information of a switching point at which the car mode is switched to the pedestrian mode and the destination in association with each other.

7. The navigation device according to claim 5, further comprising
a detection section which detects whether or not a main body of the navigation device is mounted on a car,
wherein, when the detection section detects that the main body of the navigation device is mounted on the car, the switching section switches the navigation mode to the car mode.

8. The navigation device according to claim 7,
wherein the detection section detects whether or not the main body of the navigation device is attached to a predetermined base part, and
wherein, when the detection section detects that the main body of the navigation device is attached to the base part, the switching section switches the navigation mode to the car mode.

9. The navigation device according to claim 5,
wherein, when the destination set by the setting section is recorded in the storage medium, the guidance section causes information which is related to the switching point associated with the destination to be displayed on a display section.

10. The navigation device according to claim 5,
wherein, when the destination is set by the setting section, the guidance section shows a route to the switching point associated with the destination in the car mode, and shows a route from the switching point to the destination in the pedestrian mode.

11. A program for causing a computer to function as a navigation device which includes
an acquisition section which acquires position information,
a setting section which sets a destination in accordance with operation of a user,
a guidance section which shows a route to the destination by using the position information,
a switching section which switches a navigation mode to another navigation mode in accordance with operation of a user, and
a recording section which records position information of a switching point at which navigation modes are switched by the switching section and the destination in association with each other.

12. A navigation method, comprising the steps of:
acquiring position information;
setting a destination in accordance with operation of a user;
switching a navigation mode to another navigation mode in accordance with operation of a user;
recording position information of a switching point at which the navigation modes are switched and the destination in association with each other; and
showing a route to the destination via the switching point by using the position information when the switching point is associated with the destination set in accordance with operation of a user.
